(19) United States
(12) Patent Application Publication
(10) Pub. No.: US 2010/0088360 A1
(43) Pub. Date: Apr. 8, 2010

(54) METHODS FOR DYNAMICALLY UPDATING VIRTUAL DESKTOPS OR VIRTUAL APPLICATIONS

(76) Inventors: Joe Jaudon, Sedalia, CO (US); Adam Williams, Aurora, CO (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/245,662

(22) Filed: Oct. 3, 2008

(51) Int. Cl. G06F 15/16

(52) U.S. Cl. 709/203

(57) ABSTRACT

Methods and systems for dynamically updating a computer system are provided. In some embodiments, these methods and systems collect information pertaining to a desktop unit in access by a user; provide the information to a network service on a server; send the information to a network service associated with a desired service; send the information to a user session; update a desktop unit variable; and initiate an event based on the updated unit variable.

### TECHNICAL FIELD

The present invention relates to computer network communication, and more particularly, some embodiments relate to methods and systems for dynamically updating virtual desktops or virtual applications run over a computer network.

### DESCRIPTION OF THE RELATED ART

Various computer systems may use a thin-client or virtual desktop display in conjunction with a centralized server or mainframe. A thin-client can be a client computer that includes hardware, software, or both in a client-server architecture network. Such a network may use a central server for processing activities and might transmit and receive input and output over a network or other communication medium established between the client and the remote server. In some examples, a thin-client device might run web browsers or remote desktop software, such that significant processing may occur on the server. Some devices may run a form of operating system, however, generally, the thin-client device may function as an input and output device that displays software running in another location and provides input to a processor located in another location. Thin clients may also be called “access terminals”, “dumb terminals”, or simply “terminals.”

The term “thin-client”, may include any device that might be used as a thin-client, even if the device has greater capabilities. For example, a thin-client may be a personal computer, desktop computer, laptop computer, personal digital assistant, or other electronic device connected to a mainframe or other computer. The mainframe or other computer might be a mainframe, personal computer, laptop computer, desktop computer, minicomputer, workstation, etc.

One conventional thin-client system is a product known as “Sun Ray” by Sun Microsystems, Inc. Sun Ray is an enterprise thin-client or virtual desktop display solution that is based on a centralized server or mainframe architecture including Sun Ray thin-clients or desktop units and Sun Ray software, which manages the desktop units and resides directly on compatible servers. Sun Ray devices are considered “stateless” devices because no applications, data, or operating system resides directly on the device (other than, e.g., data related to the display or recently input data from the keyboard, etc.) For this reason, the stateless devices generally require little or no direct administration.

The Sun Ray mainframe type architecture allows for a number of benefits, one of which is termed “smooth roaming” or “hot-desking.” Smooth roaming or hot-desking is the ability for a user to move from one Sun Ray type client to another and gain access to the same session, such as an application or desktop environment.

Virtual desktops and applications within a Microsoft® Enterprise are served via dedicated servers using virtualization products such as Microsoft Terminal Services, Citrix® Presentation Server, and products related to Virtual Desktop Infrastructure (e.g., VMWare, Microsoft HyperV, Citrix XenDesktop), and displayed on PCs, laptops, thin-clients or other similar devices.

FIG. 1 (prior art) is a diagram illustrating a conventional virtual application deployment. Referring now to FIG. 1, a desktop or application 102 resides on a server and is presented directly to a client device 104. The client device may be a PC, laptop computer, desktop computer, thin-client or similar device. A virtual session 110 obtains specific client information or variables, such as IP-Address and client-name associated with the client device presenting the virtual session. When a user accesses the virtual session 110 from a different client device 106, the specific client information or variables are update such that applications, services, and logs associated with the variables (e.g., IP-Address or client-name, etc.) might function as intended.

When a user initiates a session 108 at the client device 104, the session IP-Address is equal to the IP-Address of the client device 104 and the client-name is equal to the client-name of the client device 104. Conversely, when a user initiates a session 110 at the client device 106, the session IP-Address is equal to the IP-Address of the client device 106 and the client-name is equal to the client-name of the client device 106. Accordingly, functionality of applications that require location specific parameters may function correctly.

FIG. 2 (prior art) is a diagram illustrating another conventional virtual application deployment. Referring now to FIG. 2, desktop or application sessions 202 may be displayed using, for example, virtualization products within a Microsoft Enterprise such as Microsoft Terminal Services or Citrix Presentation Server, Virtual Desktop Infrastructure, etc. When using, for example, a Sun Ray thin-client solution 204 to display a desktop or application, session variables are not dynamically updated as a user roams from one desktop unit 206 to the next 208. Such session variables may include IP-Address, client-name, etc. Consequently, any applications, services, or logs that depend upon client device specific information such as IP-Address or client-name, may not function as intended.

In some cases, the IP-Address provided to the virtual session 202 is the IP-Address of the Sun Ray/Mainframe Server 204 and not the client device or desktop unit 206 or 208 from which the user is accessing. This may occur when utilizing a Sun Microsystems, Sun Ray thin-client solution to pass-through and display virtual desktops or applications common to a Microsoft environment. As a user roams between desktop units 206 and 208, the IP-Address remains static and continues to represent the Sun Ray/Mainframe Server 204, which displays the user session at the desktop unit 206 or 208. Consequently, any applications, services or logs that depend upon a current, updated IP-Address of the device from which the user is accessing might not function as intended.

In another example, the client-name provided to a virtual session may be the media access control address of the client device or desktop unit 206 used to start the session. As a user roams between desktop units 206 and 208 accessing the same virtual desktop or application, the client-name remains the same, e.g., the media access control address of the desktop unit 206 from which the initial session was gained. In other words, the client-name is not dynamically updated. Therefore, any applications, services or logs that depend upon a current, updated client-name of the device from which the user is accessing, may not function as intended.

Additionally, the Sun Ray enterprise or mainframe environment may be limited in how information or commands are passed and its ability to communicate and control a Windows desktop or application it is displaying. Session Protocols (e.g., Remote Desktop Protocol or Citrix Independent Computing Architecture) on which a virtual desktop or applications are displayed do not generally allow commands to be directed at the system level of the virtual session. Currently, Sun Ray interaction with a virtual desktop or application may be limited to a few actions that accept keystrokes to initiate events, e.g., desktop session lock. This method can be unreliable because keystrokes may be blocked when user sessions are performing other tasks. For example, in some cases keystrokes sent to initiate a session lock might be ignored or lost, leading to instances of open, unsecured user sessions.

### BRIEF SUMMARY OF EMBODIMENTS OF THE INVENTION

According to various embodiments of the invention, methods and systems described herein may be used to update a computer system. In some embodiments, these methods and systems collect information based on a user accessing a desktop and providing information to a network service that may be run from a server. The information may be sent to a network service associated with a desired service, and to a user session to update a desktop unit variable.

In various embodiments, events may be initiated based on an updated unit variable. For example, some systems may base certain actions on the location of a user. When a user is roaming from one terminal to another, dynamic updating might be used to update information related to the current location of the user.

In some embodiments, the information received may include an IP-Address or a media access control address. Additionally, in various embodiments, the methods and systems described herein may compare the information to check that the information is current. A dynamic updating system might check the media access control address of a terminal to ensure that the media access control address of that terminal matches the media access control address where the user is believed to be located. The comparison can occur after the information is sent back to the desktop unit.

Additionally, in various embodiments, the information received might include a token identification, printer information, location information, screensaver information, or authentication information. In some dynamic updating systems, the network service and the network service associated with a desired service might be the same network service. In other embodiments, these might be two separate network services.

As will be understood by those of skill in the art, the network service associated with a desired service may change as services desired by a user change. In some embodiments, the updated unit variable comprises a predetermined file. In other embodiments, the updated unit variable comprises a system registry variable. Some embodiments may update a predetermined file, a system registry variable, or both.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 (prior art) is a diagram illustrating a conventional virtual application deployment.

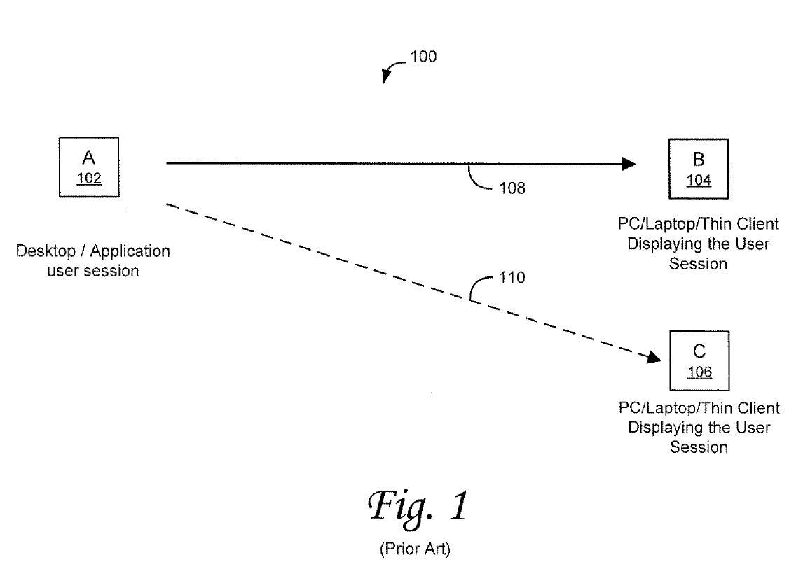

FIG. 2 (prior art) is a diagram illustrating another conventional virtual application deployment.

FIG. 3 is a diagram illustrating an example system in accordance with the principles of the invention.

FIG. 4 is a diagram illustrating an example system in accordance with the principles of the invention.

FIG. 5 is a flowchart illustrating a method in accordance with the principles of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION

The present invention relates to computer network communication, and more particularly, some embodiments relate to methods and systems for dynamically updating virtual desktops or virtual applications run over a computer network. One example environment that might be used in conjunction with the methods and systems described herein is the Sun Ray thin-client solution by Sun Microsystems, Inc. Sun Ray is a stateless thin-client solution that is commonly marketed toward corporate users.

Sun Ray may include a device that displays applications that are running on a server that might not be collocated with the display device. The user's session is generally independent of the display. Accordingly, Sun Ray sessions are generally “portable.” In other words, a user can go from one Sun Ray device to another and continue their work without closing any programs. Sun Ray clients may be connected to a Sun Ray Server via a computer network, such as an Ethernet network or other network.

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments. For example, other thin-client solutions and/or other portable computing session solutions in addition to Sun Ray might be implemented using the methods and systems described herein.

Various embodiments of the methods and systems described herein allow for dynamic updating of a variable or variables related to a desktop unit or similar device. Example devices may include, e.g., Microsoft virtual desktops and/or virtual applications with a Sun Microsystems Client Sun Ray system. In some embodiments, this allows for direct TCP/IP connections to each virtual desktop. This may be used to provide various devices with different functionality including, in some systems, devices associated with USB including Windows Plug and Play, locally attached printing, IP soft-phones, dictation, etc.

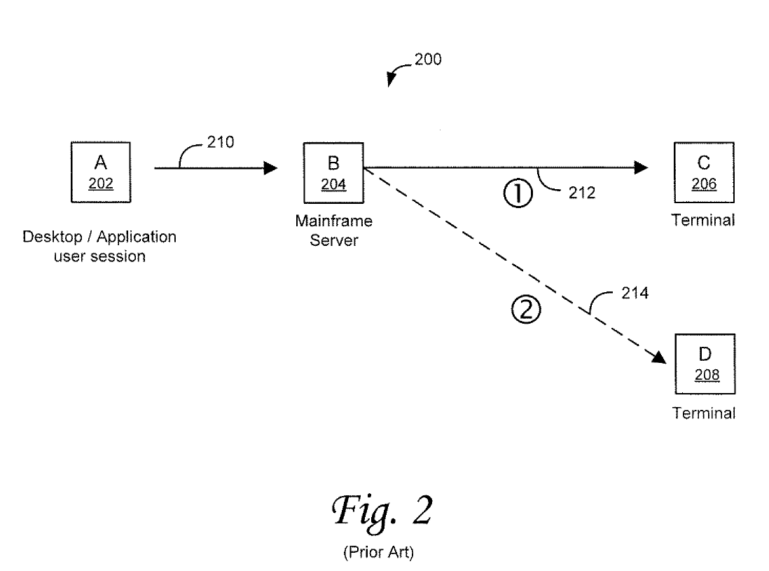

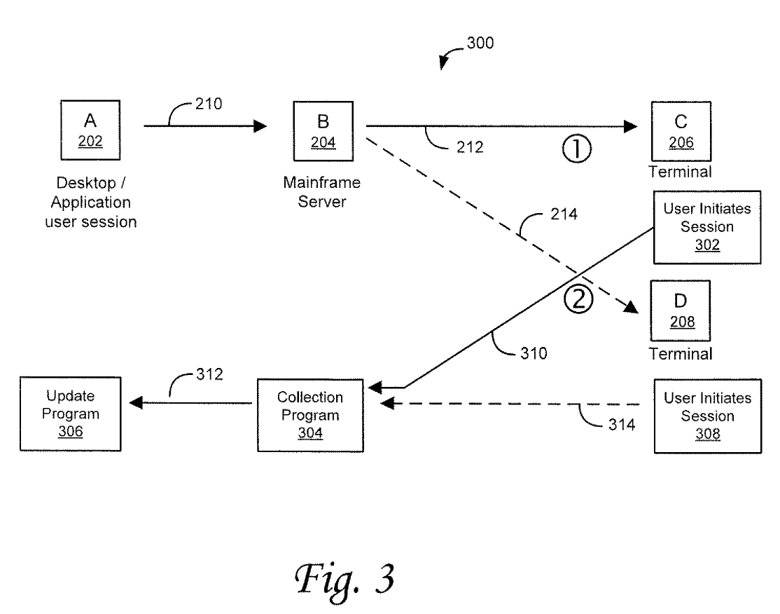

FIG. 3 is a diagram illustrating an example system in accordance with the principles of the invention. Referring now to FIG. 3, an example computer system 300 is illustrated. The computer system 300 is similar in some respects to the computer system 200 illustrated in FIG. 2, and like elements are numbered accordingly. However, the computer system 300 further includes various systems described herein to allow for dynamic updating of virtual desktops or virtual applications.

As illustrated in FIG. 3, a user initiates a session 302 at terminal 206. A collection program 304, triggered by user access of a desktop unit or similar device, collects variables or information associated with the current desktop unit being accessed. For example, in some embodiments, the information might include the current IP-Address, media access control address (client-name), Token ID, or other information regarding the terminal. Terminal information may include, but is not limited to, printer, location, screensaver, authentication information, etc. Collected information or variables reside in memory and/or an associated database or databases.

Additionally, the collection program 304 may provide information to the network service located on server 204. With dynamic updating, the collection program may run on a mainframe, or server 204. By way of example, the server 204 may be a Sun Ray Mainframe Server. A network service may send the information to a network service associated with an appropriate virtual desktop and/or application server. In some cases, a single network service might receive the information from the server and that same service might be associated with an appropriate virtual desktop and/or application server. Additionally, the desktop and/or application server's network service may send the information to the user session.

When a user smooth roams to terminal 208 and initiates a session 308, the collection program 304 may be initiated to collect data sent to an update program 306. The update program 306 may dynamically update appropriate variables on the desktop and/or application user session 308.

In some embodiments, a client program running on a user session may update the system registry and/or any other selected files with appropriate desktop unit variables. The client program may use collected information or variables to initiate events associated with the user session 308 or initiate programs associated with user session 308.

In various embodiments, the same information may be transmitted back to a terminal 308 and compared with the information collected within the collection program 304 to determine if the information is correct and current. If information is not the same, appropriate logging and error correction techniques may be used to correct the error, determine how the error occurred, etc. The dynamic updating system may update the information and note the error in a log. In some embodiments, the system may transmit the data back to the terminal after correction to determine if it has been corrected.

In various embodiments, the methods and systems described herein may dynamically update session appropriate variables of a Microsoft virtual desktop session with the appropriate IP-Address in a mainframe environment. For example, in some systems, there can be various variables related to IP that may be updated within a windows session. Generally, however, the IP address of, e.g., the SunRay server should stay the same or the session would be redirected away from the SunRay server directly to the SunRay data transfer unit. Accordingly, in some embodiments, only session appropriate variables will be updated, while variables that generally are required to stay the same are unchanged, allowing the system to function as described herein.

The dynamic updating system may dynamically update (i) the Microsoft virtual desktop session client-name/media access control address in mainframe environment while smooth roaming, or (ii) the session IP-Address in a mainframe environment. Some embodiments may dynamically update the Microsoft Virtual Applications session client-name/media access control address in a mainframe environment while smooth roaming. Other virtual desktop systems may also be updated using the systems and methods described herein.

Error checking and monitoring of the dynamic updating process between a mainframe and a virtual environment might also be performed to ensure functionality. Additionally, some embodiments allow for methods of executing commands, applications and system events on, for example, a Microsoft virtual desktop leveraging events or actions within a mainframe environment such as a Sun Ray enterprise system. Some embodiments allow for the centralized logging of virtual and mainframe environments.

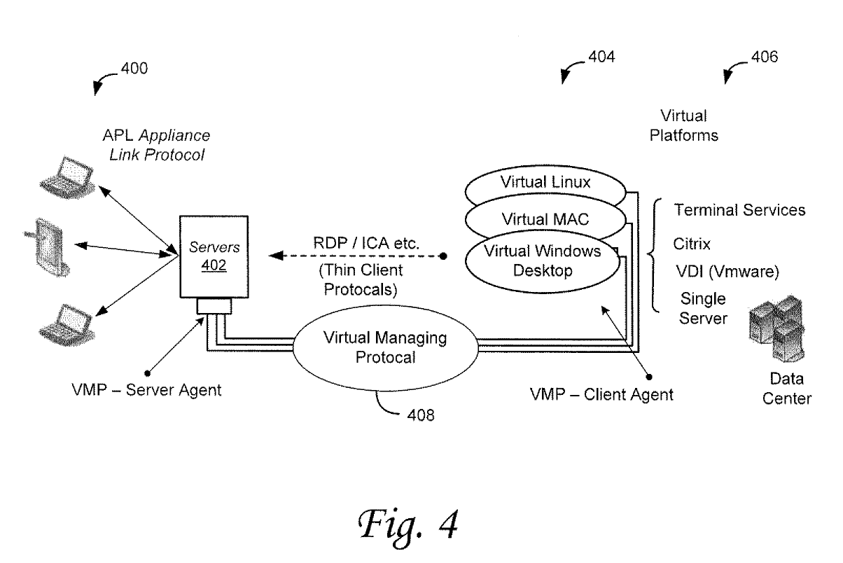

FIG. 4 is a diagram illustrating an example system in accordance with the principles of the invention. Referring now to FIG. 4, terminals 400 may include laptop computers, desktop computers, workstations, personal digital assistants or other electronic computing devices. These devices 400 may communicate with one or more servers 402 in communication with various virtual platforms 404 and data centers 406 using, for example, a thin-client protocol. The thin-client protocol might be Remote Desktop Protocol, or Independent Computing Architecture, e.g., Citrix. A virtual management protocol 408 might be used to implement the methods and systems described herein to dynamically update a virtual desktop and/or virtual application as a user roams between different devices 400.

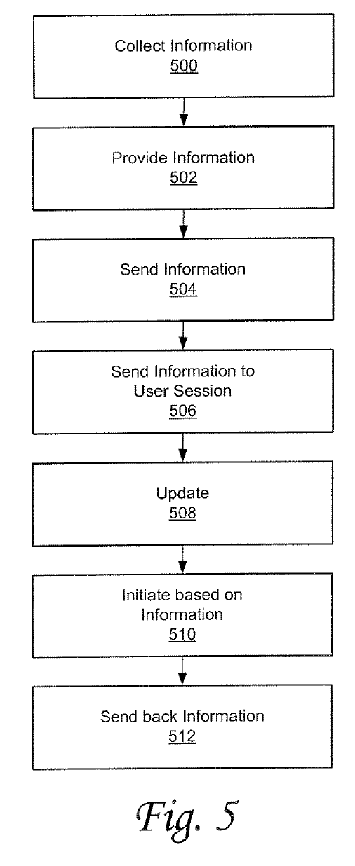

FIG. 5 is a flowchart illustrating a method in accordance with the principles of the invention. Referring now to FIG. 5, in step 500, information is collected. A user accessing a desktop unit, such as a desktop computer, laptop, etc, may trigger the information collection. The information may include, but is not limited to, the current IP-Address, media access control address (client-name), Token ID, or other information regarding the terminal. The terminal information may include, but is not limited to, printer, location, screensaver, authentication information, etc. Collected information or variables may reside in memory or an associated database or databases.

In step 502, the information is provided to a network service located on a server. The server may be a mainframe, minicomputer, personal computer, etc. The dynamic updating system may include a server that runs a program for collecting information, e.g., current IP-Address, media access control address (client-name), Token ID, or other information regarding the terminal.

In step 504, the information is sent to a network service associated with an appropriate virtual desktop and/or application server. In some cases, a single network service might receive the information from the server and that same service might be associated with an appropriate virtual desktop and/or application server.

In step 506, the desktop and/or application server's network service sends the information to the user session. In step 508, information is updated when the user smooth roams to another terminal and initiates another session. A collection program may be initiated to collect data that can be sent to an update program. The update program may dynamically update appropriate variables on the desktop and/or application user session. In some embodiments, a client program running on a user session may update the system registry and/or any other selected files with appropriate desktop unit variables.

In step 510, the client program uses collected information or variables to initiate events associated with the user session or initiate programs associated with the user session when a user roams to another desktop unit.

In step 512, the same information is transmitted back to a terminal and compared with the information collected within the collection program. If the information is not the same, appropriate logging and error correction techniques may be used to correct the error, determine how the error occurred, etc.

The methods and systems described herein might be used to support various aspects of computer operation. For example, in some cases, mainframe printing functionality might be improved using these methods and systems. Mainframe printing within a Microsoft Enterprise relies upon the correct client-name or IP-Address of a client device to print to the correct location. When accessing a Microsoft Windows® environment via Sun Ray or similar device, the client-name and IP-Address of the user/virtual sessions are not updated in a standard manner; nor are they updated dynamically when a user smooth roams from terminal to terminal. Various embodiments allow for the dynamic updating of the virtual desktop or application with the proper terminal client-name (media access control address) and IP-Address as smooth roaming occurs. Using the correct updated client information, centralized mainframe printing can be directed to the appropriate printer while smooth roaming using Sun Ray or a similar mainframe desktop device.

Various embodiments also allow for dynamic updating of a virtual session with user and terminal demographics (e.g., IP-Address and client information) being displayed by Sun Ray or mainframe environment during smooth roaming. The updated information may be used by policies related to desktop and user controls, for example, security, data access, application delivery and device control.

Further embodiments allow for centralized logging of various terminal events related to the user. Some examples include, but are not limited to, user movement such as: (i) time, date and place of access; (ii) when a user is attempting to use an incorrect badge, e.g., smart card; (iii) the type of session access and server they are logged into; and (iv) other user movements. The system may pass this logged information to any enterprise logging or monitoring system.

Some embodiments may be used to allow for higher level commands such as system calls that are passed directly to a Windows session. This may allow for increased control and reliability. For example, various embodiments may leverage system calls for a “session lock,” which may allow for a method of ensuring a virtual session is locked upon user exit.

Dynamic updating may provide a “bridge” between a mainframe environment, a Microsoft Enterprise environment, and a third party applications, to allow for dynamic control of application deployment, access, and environment during smooth roaming or dynamic control of desktop sessions involving the user experience and control of devices during smooth roaming.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

The term “tool” can be used to refer to any apparatus configured to perform a recited function. For example, tools can include a collection of one or more modules and can also be comprised of hardware, software or a combination thereof. Thus, for example, a tool can be a collection of one or more software modules, hardware modules, software/hardware modules or any combination or permutation thereof. As another example, a tool can be a computing device or other appliance on which software runs or in which hardware is implemented.

As used herein, the term module might describe a given unit of functionality that can be performed in accordance with one or more embodiments of the present invention. A module might be implemented utilizing any form of hardware, software, or a combination thereof. For example, one or more processors, controllers, ASICs, PLAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, these software elements can be implemented to operate with a computing or processing module capable of carrying out the functionality described with respect thereto. An example-computing module is discussed. Various embodiments are described in terms of the example-computing module. After reading this description, it will become apparent to a person skilled in the relevant art how to implement the invention using other computing modules or architectures.

In one example, the computing module may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. The computing module might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Additionally, the computing module might include, for example, one or more processors, controllers, control modules, or other processing devices. The processor might be implemented using a general-purpose or special-purpose processing engine such as, for example, a microprocessor, controller, or other control logic. The processor may also be connected to a bus, although any communication medium can be used to facilitate interaction with other components of computing module or to communicate externally.

The computing module might also include one or more memory modules, simply referred to herein as main memory. For example, preferably random access memory (RAM) or other dynamic memory, might be used for storing information and instructions to be executed by the processor. The main memory might also be used for storing temporary variables or other intermediate information during execution of instructions to be executed by processor. The computing module might likewise include a read only memory (“ROM”) or other static storage device coupled to the bus for storing static information and instructions for the processor.

The computing module might also include one or more various forms of information storage mechanism, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, the storage media, might include, for example, a hard disk, a floppy disk, magnetic tape, cartridge, optical disk, a CD or DVD, or other fixed or removable medium that is read by, written to or accessed by the media drive. As these examples illustrate, the storage media can include a computer usable storage medium having stored therein computer software or data.

In alternative embodiments, an information storage mechanism might include other similar instrumentalities for allowing computer programs or other instructions or data to be loaded into the computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

The computing module might also include a communications interface. The communications interface might be used to allow software and data to be transferred between computing module and external devices. Examples of a communications interface might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via a communications interface might typically be carried on signals, which can be electronic, electromagnetic (which includes optical) or other signals capable of being exchanged by a given communications interface. These signals might be provided to the communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, a memory, storage unit, a media, and signals on channel. These and other various forms of computer program media or computer usable media may be involved in carrying one or more sequences of one or more instructions to a processing device for execution. Such instructions embodied on the medium, are generally referred to as “computer program code,” a “computer program,” or a “computer program product” (which may be grouped in the form of computer programs or other groupings). When executed, such instructions might enable the computing module to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of ordinary skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for updating a computer system comprising
collecting information pertaining to a desktop unit in access by a user;
providing the information to a network service on a server;
sending the information to a network service associated with a desired service;
sending the information to a user session;
updating a unit variable of the desktop unit; and
initiating an event based on the updated unit variable.

2. The method of claim 1, further comprising comparing the information.

3. The method of claim 2, wherein the comparison occurs after the information is sent to the user session.

4. The method of claim 1, wherein the information comprises a token identification.

5. The method of claim 1, wherein the information comprises printer information.

6. The method of claim 1, wherein the information comprises location information.

7. The method of claim 1, wherein the information comprises screensaver information.

8. The method of claim 1, wherein the information comprises authentication information.

9. The method of claim 1, wherein the network service on the server comprises the network service associated with a desired service.

10. The method of claim 1, wherein the updated unit variable comprises a predetermined file.

11. The method of claim 1, wherein the updated unit variable comprises a system registry variable.

12. The method of claim 1, wherein the information comprises an internet protocol address or a media access control address.

13. A method for updating a computer system comprising:
collecting information pertaining to a desktop unit in access by a user;
providing the information to a network service on a server; and
comparing the information to determine whether the desktop unit is a thin-client device.

14. The method of claim 13, wherein the information comprises an internet protocol address, a media access control address, or a token identification.

15. The method of claim 13, wherein the information comprises printer information, location information, screensaver information, or authentication information.

16. The method of claim 13, wherein the network service on the server comprises the network service associated with a desired service.

17. The method of claim 13, wherein the updated unit variable comprises a predetermined file.

18. The method of claim 13, wherein the updated unit variable comprises a system registry variable.

19. A method for updating a computer system comprising:
receiving information pertaining to a desktop unit in access by a user;
updating a desktop unit variable based on the information;
initiating an event based on the updated unit variable; and
sending information back to the desktop unit.

20. The method of claim 19, wherein the updated unit variable comprises a predetermined file.

21. The method of claim 19, wherein the updated unit variable comprises a system registry variable.
